(19) United States
(12) Patent Application Publication
(10) Pub. No.: US 2003/0049522 A1
(43) Pub. Date: Mar. 13, 2003

(54) Battery tester label

(76) Inventor: Marinus A. Doomernik, Simpsonville, SC (US)

Correspondence Address: Jay R. Campbell, Renner, Otto, Boisselle, & Sklar, L.L.P., 19th Floor, 1621 Euclid Avenue, Cleveland, OH, 44115, US

(21) Appl. No.: 09/954,690

(22) Filed: Sep. 12, 2001

(51) Int. Cl. H01M 10/48

(52) U.S. Cl. 429/93; 429/90

(57) ABSTRACT

A multilayer label for a battery is disclosed that includes a transparent, shrinkable outer film forming the outermost layer of the label, a transparent, shrinkable carrier film having a first transparent adhesive layer on one side confronting the outer layer and bonding the carrier layer to the outer layer and an outwardly visible indicia layer on other side, and a second transparent adhesive layer adjacent the indicia layer for bonding the label to the battery. The label may also include a thermochromic material and the layer of conductive material forming a battery power indicator. When a battery tester is incorporated in the label the length of the film may exceed the circumference of the battery by at least the width of the battery power indicator so that when the label is wrapped around the battery, the battery power indicator is situated between two portions of the film and thermally insulated from the battery by the label.

### FIELD OF THE INVENTION

This invention relates generally to battery labels and battery testers and, more specifically, to battery testers incorporated into a label on a battery.

### BACKGROUND OF THE INVENTION

In recent years many dry cell batteries have been provided with a battery tester incorporated into the battery label for testing the relative power remaining in the battery. Examples of these batteries are those sold by Duracell and Eveready. Typically, these batteries include one or more layers of a heat shrinkable film covering the cylindrical portion of the battery forming a label with a battery tester laminated or otherwise attached to the interior of the label and contacting the battery. Such a configuration presents many challenges. For example, it is desirable to make the label and battery tester as inexpensive as possible as well as thin to maximize the portion of the overall battery volume that can be contributed to the electrochemical components of the battery. However, most testers employ a thermochomic material and a conductive heating circuit for heating the thermochromic material that must be thermally insulated from the battery. There are many insulators that have been used or proposed to thermally isolate the thermochomic battery tester from the battery, such as insulators that are printed upon the testers or paper or film insulators that inserted between the battery tester and the battery. While these insulators are effective, they add to the cost and complexity of the tester and can be bulky.

In the past, several different types of labels have been employed in conjunction with batteries. These include what have been commonly referred to as “triplex,” “duplex” and “simplex” labels, generally denoting the number of layers of heat shrinkable, polymeric film layers employed in the label. Each different type of label construction has its own advantages and disadvantages. Examples of triplex, duplex and simplex labels are illustrated in FIGS. 1-4, captioned, “Prior Art.”

Referring specifically to FIG. 1, the triplex construction consists of a composite laminate 10 of a first heat shrinkable, self-supporting, polymeric film layer 12 on which there is applied a layer of a metal 14 normally formed by vapor deposition, onto which there is added a second self-supporting, heat shrinkable, polymeric film layer 16, a graphics layer 18 and a top protective layer of another self-supporting, heat shrinkable, polymeric film layer 20. A pressure-sensitive adhesive layer 22 is applied to the undersurface of film layer 20.

In the duplex construction 24, shown in FIG. 2, the first intermediate heat shrinkable polymer layer 16 is eliminated from the triplex construction to provide a laminate of a first heat shrinkable polymer film layer 26 onto which there is provided a metallized layer 28, a pigmented layer 30, and the heat shrinkable polymer layer 32. The heat shrinkable polymer film layer 32 is undercoated with the pressure-sensitive adhesive layer 34. In either of the duplex or triplex constructions, where a bond is weak, particularly between a self-supporting, heat shrinkable polymer layer and a layer of metal, it has been common to utilize a layer of adhesive to enhance the strength of the bond. Multilayer label constructions are described, for instance, in U.S. Pat. Nos. 4,801,514, 4,911,994, 5,032,477, 5,262,251 and 5,312,712, to Will et al., each incorporated herein by reference.

Multiple layer constructions also present problems of matching the shrink characteristics of the several polymeric films so that no slip occurs between adjacent, heat shrinkable, polymeric film layers upon the heat shrinkage operation. If the heat shrink characteristics are not properly matched, especially because of the location of the graphic metallized layers between the polymeric films, distortion of the graphics, puckering and possible delamination can occur.

In contrast to the triplex and duplex label constructions, a simplex construction 36, shown in FIG. 3, includes a single self-supporting heat shrinkable layer. A simplex label thus typically includes a self-supporting, heat shrinkable layer 38; a supported alkali-resistant pigmented layer 40, which is electrically non-conductive at least in regions where it may come into contact with conductive regions of the battery case; and a supported, pressure-sensitive adhesive layer 42, which is also electrically non-conductive in those areas where it may contact conductive regions of the battery case. A simplex label is described, for instance, in U.S. Pat. No. 5,747,192 to Hughen, et al., incorporated herein by reference.

Simplex constructions, while typically less expensive than multiple layer constructions, may also have some disadvantages. For example, it is often easier to construct a label in different steps on two or more polymeric films and laminate them to form the final product, than to build up all of the layers in successive operations on a single film. Further, by using at least two different polymeric film layers, improved overall shrinkage properties can be achieved so that the combined film performs better than any of the films individually.

In any of these label constructions, a battery tester 50 is laminated to or built up on the inner surface of the label 52 contacting the battery case 54 so that when the label is wrapped around the battery, the tester is situated between the battery case and the label, as shown in FIG. 4. Typical battery testers include a thermochromic material that undergoes a visual change when heated above a certain temperature. Such a tester includes a substrate upon which is deposited an electrically conductive layer, such as silver, a layer or color or graphics and a layer of a thermochromic material in thermal contact with the conductive layer. When opposite ends of the silver layer are connected to the terminals of the battery, heat is generated in the conductive layer proportional to the remaining power or charge in the battery. The heat is transferred to the thermochromic layer, which undergoes a visual change in appearance. The tester may be calibrated to indicate the relative charge of the battery or it may simply indicate whether the battery has adequate charge or not, commonly referred to as a go/no go tester. Exemplary thermochromic battery testers are described in U.S. Pat. No. 5,614,333 to Hughen et al. and U.S. Pat. No. 5,578,390 to Hughen, both of which are incorporated herein by this reference.

It would be desirable to provide a battery tester and label that was less expensive to manufacture and less bulky than many conventional labels and battery testers and that did not suffer from some of the disadvantages of the prior art labels and battery testers.

### SUMMARY OF THE INVENTION

In accordance with one aspect of the invention, a multilayer label for a battery includes a transparent, shrinkable outer film forming the outermost layer of the label; a transparent, shrinkable carrier film having a first transparent adhesive layer on one side confronting the outer layer and bonding the carrier layer to the outer layer and an outwardly visible indicia layer on other side; and a second transparent adhesive layer adjacent the indicia layer for bonding the label to the battery.

In accordance with another aspect of the invention, a battery power indicator label for a dry-cell battery includes at least one transparent, shrinkable base film having a printed indicia layer, a layer of thermochromic material, a layer of electrically conductive material and a pressure sensitive adhesive on one side, with the layer of thermochromic material and the layer of conductive material forming a battery power indicator; wherein the length of the film exceeds the circumference of the battery by at least the width of the battery power indicator so that when the label is wrapped around the battery, the battery power indicator is situated between two portions of the film.

In accordance with a further aspect of the invention a multilayer battery power indicator label for a battery includes a transparent, shrinkable outer film forming the outermost layer of the label; a transparent, shrinkable carrier film having a first transparent adhesive layer on one side confronting the outer layer and bonding the carrier layer to the outer layer and an outwardly visible indicia layer; a layer of thermochromic material; a layer of electrically conductive material and a second adhesive layer on the other side; with the layer of thermochromic material and the layer of conductive material cooperatively acting as a battery power indicator; and a release liner confronting the second adhesive layer.

In general, the invention comprises the foregoing and other features hereinafter fully described and particularly pointed in the claims, the following description and the annexed drawings setting forth in detail a certain illustrated embodiment of the invention, this being indicative, however, of but one of the various ways in which the principles of the invention may be employed.

### BRIEF DESCRIPTION OF THE DRAWINGS

In the annexed drawings:

FIG. 1 is a schematic view of a prior art triplex multiple layer battery label;

FIG. 2 is a schematic view of a prior art duplex multiple layer battery label;

FIG. 3 is a schematic view of a prior art simplex layer battery label;

FIG. 4 is a perspective view of a battery with a prior art battery label and battery tester in a partially wound state to illustrate the location of the label and battery tester relative to the battery;

FIG. 5 is a schematic view of a multiple layer battery label of the present invention;

FIG. 6 is a schematic view of a multiple layer battery label of the present invention including a thermochromic battery tester;

FIG. 7 is a perspective view of a battery with the battery label and battery tester of the present invention in a partially wound state to illustrate the location of the label and battery tester relative to the battery; and

FIG. 8 is a schematic end view of a battery with a label and battery tester of the present invention.

### DETAILED DESCRIPTION OF THE INVENTION

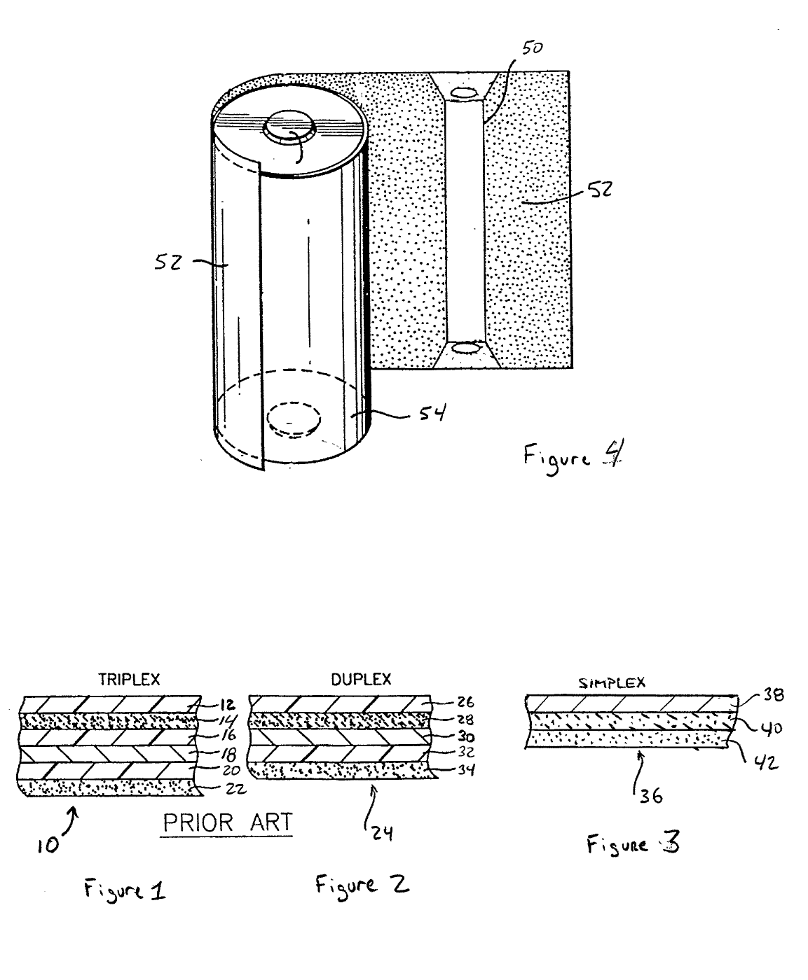

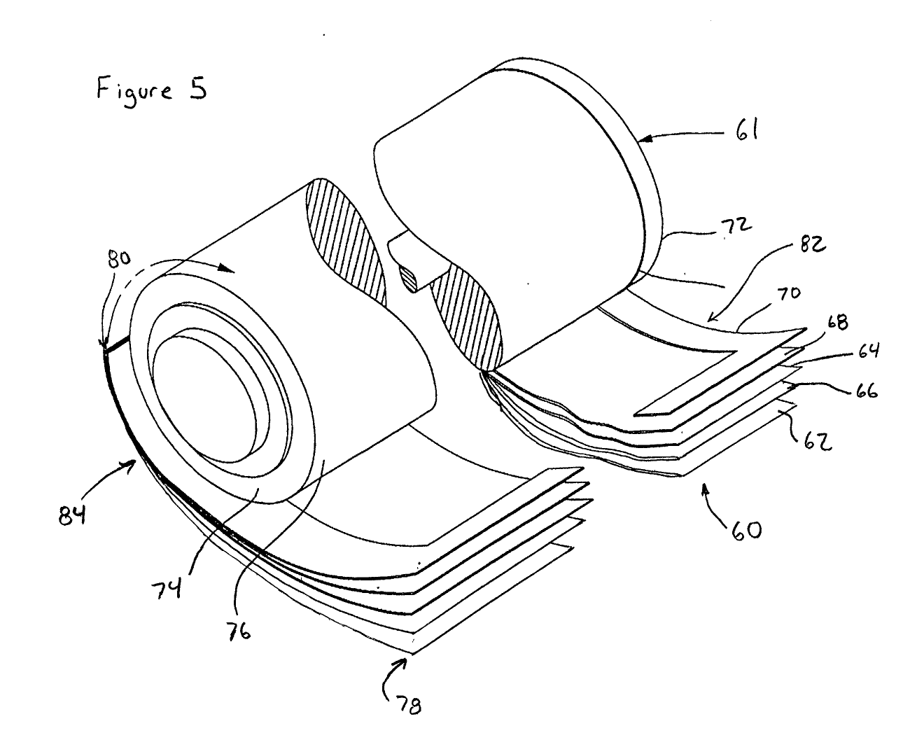

With reference to the figures and initially to FIG. 5 there is shown a construction for a battery label 60 of the present invention partially wrapped around a conventional dry-cell battery 61 such as a Duracell or Eveready “AA,” ““AAA,” “C” or “D,” for example. The battery label 60 includes an outer transparent self-supporting heat shrinkable film 62, an inner transparent self-supporting heat shrinkable film 64 laminated to the outer film 62 by a laminating adhesive 66, a label graphics layer 68 printed on the surface of the inner film 64 remote from the outer film and a layer of pressure sensitive adhesive 70 covering a portion of the label graphics layer. The battery label may be referred to as a “dual simplex” construction by virtue of the fact that it includes two layers of self-supporting heat shrinkable film with the graphics layer printed on the inner film remote from the outer film, like in the simplex design shown in FIG. 3, as opposed to between the films as is common in conventional triplex or duplex designs, like those shown in FIGS. 2 and 3. Prior to application to a battery 61, the label 60 also preferably includes a removable release liner (not shown) in contact with the pressure sensitive adhesive 70. The release liner would, of course, be removed prior to the label being applied to a battery.

The dual simplex film of the present invention offers several advantages. Because at least two self-supporting films are employed, the individual films can be chosen to complement each other so that films can be employed that are each best suited to an efficient manufacturing process with a resulting product that has desirable heat shrink capabilities and that can withstand the rigors of an application as a battery label. Since the label graphics layer is not contained between the films, the heat shrink characteristics of the films do not have to be matched in a way to avoid distortion of the graphics and puckering that can occur due to slippage between the self-supporting films during the heat shrink process, nor is possible deleterious interaction between the graphics layer and the laminating adhesive a problem.

Preferably, the outer film 62 is a substantially balanced oriented polyvinylchloride film, meaning it has substantially same shrinkages values in both cross-directions, manufactured by Alcoa Flexible Packaging of Grottoes Va. The outer film 62 may shrink upon the application of heat up to about 20%, but preferably from about 10% to about 15%. The inner or carrier 64 is preferably a monoaxially oriented polymer film, which is oriented substantially in the direction normal to the long axis of the battery, i.e., around the circumference of the battery. The inner film 64 may shrink upon the application of heat up to about 60%, but generally from about 20 to about 60%, and preferably from about 40 to about 50% or most preferably from about 40 to about 45% for smaller batteries and 40 to 50% for larger batteries. The inner film 64 may also experience some shrinkage in the direction parallel to the long axis of the battery, but it is preferably minor, for example, −2 to +5%, preferably 0-3%, even more preferably about 0-1% (negative shrinkage means elongation). The shrinkage characteristics chosen for the inner or outer films 62 and 64 may vary depending upon the intended production rate. Residual shrink-back in storage for the films 62 and 64 should be not more than about 10%, preferably less than 8%, more preferably less than about 3%. The outer film 62 is preferably in the range of about 10-25 microns thick, while the inner film is preferably in the range of about 25-50 microns thick.

The presently preferred mechanical properties of the films are a tensile strength of about 15 Kpsi in the machine direction, an elongation of 77% in the machine direction, and elastic modulus of 400 Kpsi in the machine direction, as measured according to ASTM D882-91 (Test Method A).

One exemplary heat shrinkable polymer suitable for the film layer 64 is a substantially monoaxially oriented polyvinyl chloride film manufactured by Klockner Pentaplast of America, Gordonsville, Va. Other heat shrinkable films that may be used for the outer film 62 and inner film 64 include polyvinyl fluoride films, vinylidine fluoride films, polyester films, polyolefin films, and the like. Additional films that are suitable include polypropylene films described in U.S. Pat. No. 5,190,609 to Lee et al., incorporated herein by reference.

The outer film 62 and inner film 64 are preferably laminated together using a conventional clear laminating adhesive 66. There are many laminating adhesives available that would function to bond the films 62 and 64 together. A suitable adhesive could be readily chosen by a person skilled in the art. Alternatively, the outer film 62 and inner film 64 could be co-extruded with similar results.

The graphics layer 68, which is provided on the surface of the inner film 64 opposite the outer film 62, contains the decorative and/or functional graphics viewable through the films 62 and 64 that form the words, images, and other visible information that makes up the battery label, such as bar codes, product information and the like. As such, the graphics layer may actually include several different colors of inks and coatings formed in layers or side-by-side. The inks used in the graphics layer are preferably alkali-resistant inks deposited from a carrier or vehicle to leave an alkali-resistant, electrically non-conductive layer. Suitable alkali-resistant, electrically non-conductive inks in colors consistent with an exemplary Duracell battery label are manufactured by Color Converting Inks of Des Moines, Iowa, including FSAI4A05 (copper), FVIH9B02 (black), and FSAA4A38 (white). The copper color ink has a pearlescent formulation, which provides a metallic appearance but is electrically non-conductive and replaces the conductive layer of metal found in many prior art label constructions.

The pressure-sensitive adhesive layer 70 may extend over the entire surface of the inner film 84 or may extend around the periphery of the label as shown in FIG. 5 and should be of a width sufficient to ensure contact with the battery case. The adhesive bond to the battery case should be sufficient to ensure that little or no shrinkage of the label will occur between zones of adhesive contact except where the label extends beyond the terminal ends of the battery.

The pressure-sensitive adhesive 70 should be transparent and may be applied from a solvent, emulsion or suspension, or as a hot melt. The pressure-sensitive adhesive 70 should have sufficient shear or cohesive strength to prevent excessive shrink-back of the label where adhered to the battery case upon the action of heat after placement of the label on a battery, sufficient peel strength to prevent the label from lifting from the battery, and sufficient tack or grab to enable adequate attachment of the label to the battery case during the labeling operation.

The presently preferred pressure-sensitive adhesive is an emulsion based acrylic adhesive manufactured by the Avery Chemical Division of Avery Dennison Corporation, under the product designation S3506, modified with the addition of a cross-linker. Another suitable solvent acrylic pressure-sensitive adhesive is Polytex.TM. 7000 manufactured by the Avery Chemical Division of Avery Dennison Corporation and described in U.S. Pat. No. 4,812,541 to Mallya et al., incorporated herein by reference. A suitable emulsion pressure-sensitive adhesive is described in U.S. Pat. No. 5,221,706 to Lin et al., incorporated herein by reference.

In order to have an overall balance of adhesive properties and to enable proper application and retention of the label intact on the battery case, it is preferred that the adhesive have a peel strength or adhesivity of at least preferably about 2 Pli, more preferably 2 to about 5 Pli, as determined by using PSTC #1 (Pressure-Sensitive Tape Council Test #1) run at 12 inches per minute peel rate after 20 minute dwell on a 2 mil polyester backing; a shear strength, a measure of cohesive strength, of at least 4,000, preferably about 4,000 to about 10,000 minutes according to PSTC Test #7 using 2 mil polyester backing, which for a sample measuring 0.5 by 0.5″ and a 500 gram weight, results in a loading of 2,000 grams per square inch; and a loop tack of at least about 2, preferably 2 to about 4 Pli, at a 12″ per minute peel rate for a 1″ wide loop on stainless steel.

Preferably, any of the label layers that contact the opposed terminals 72, 74 of the battery 61 or the battery case 76 should be electrically non-conductive, e.g., have a resistance on the order of about 560 megaohms or greater, to prevent the label from accidentally shorting the battery. However, it is not necessary that the label layers that do not contact the battery directly be electrically non-conductive and when a battery tester is employed in conjunction with the label one or more layers may be added that are electrically conductive. It is also preferable that the label materials be essentially non-responsive to the action of alkali or be alkali-resistant, e.g., exhibit little or no perceptible change in appearance upon exposure to 7.2N KOH for about 24 hours.

The label 60 is preferably sized to exceed the circumferential dimension of the battery so that the ends 78, 80 of the label overlap, allowing a secure adherence of one end of the label to the other end through the pressure sensitive adhesive 70. The label 70 also preferably extends beyond the ends 78, 80 of the battery 61 so that the lateral label end 82, 84 shrink, fold over, and are adhered by the pressure-sensitive adhesive to the opposed ends of the battery upon the application of heat. The label 60 can be applied to the battery through any number of conventional processes, such as described in U.S. Pat. No. 5,747,192 to Hughen et al.

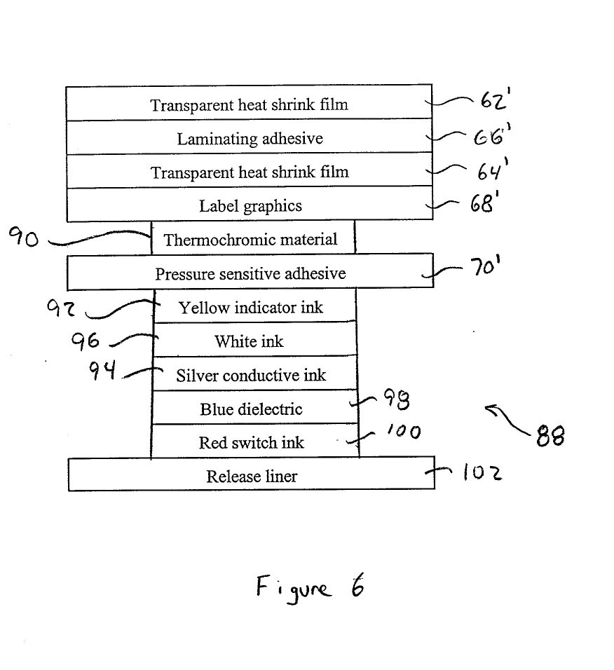

A dual simplex construction of a label 88 including a battery tester is shown schematically in FIG. 6. Like the label 60 described above, the label 88 includes an outer transparent self-supporting heat shrinkable film 62′, an inner transparent self-supporting heat shrinkable film 64′ laminated to the outer film 62′ by a laminating adhesive 66′, and a label graphics layer 68′ printed on the surface of the inner film 64′ remote from the outer film. The label 88 will also include a pressure sensitive adhesive 70′, although a layer of thermochromic material 90 may be applied to the graphics layer 68′ or as part of the graphics layer prior to the application of the pressure sensitive adhesive layer 70′. Printed atop the thermochromic material 90, or atop the pressure sensitive adhesive if it is covering the thermochromic material, is an indicator layer 92 that acts as an indicator when the thermochromic material 90 is heated above its transition point. The indicator layer 92 may include a single or graduated color in a calibrated tester that is revealed to indicate the power level, or electromotive force, of the battery or a word, such as “good” to indicate that the battery has sufficient power, as is understood in the art.

The thermochromic layer 90 may be composed of any number of reversible thermochromic inks that have a suitable transition temperature. Thermochromic inks are well known in the art. When the thermochromic layer 90 is heated to a transition temperature, preferably between about 35.degree. C. to 50.degree. C., it turns from opaque to clear thereby exposing the underlying indicating layer 92 and revealing, in the examples noted above, the word “good” or a portion of a scale. A preferred thermochromic ink for use in the thermochromic layer 90 is known as Type 41 thermochromic ink, meaning it has a transition temperature of about 41 degrees Celsius, from Matsui International Co., Inc.

To complete the battery tester is a conductive layer 94 in thermal communication with the thermochromic layer 90, an intermediate colored layer 96 between the conductive layer 94 and the indicator layer 92, for cosmetic reasons as well as to protect the conductive layer, a dielectric layer 98 electrically isolating the conductive layer 94 from the battery and a further switch layer 102 forming a switch for each battery terminal by separating the conductive layer from the battery in areas not covered by the dielectric layer 98. The label also includes a release liner 102 that is removed prior to the label being applied to the battery. Each of the layers of the label 88, with the exception of the conductive layer 94, is preferably electrically non-conductive and alkali resistant.

The conductive layer 94 may be selected from known thin film highly electrically conductive coatings. Preferably, the conductive layer 94 has a thickness of between about 0.25 mil and 1.0 mil (0.006 mm and 0.025 mm), most preferably about 0.5 mil (0.012 mm), and a sheet resistivity of between about 10 and 100 milliohms/sq. A preferred conductive coating is formed of a polymer based silver ink, composed of silver flakes dispersed in a polymer solution. A suitable silver ink is available from Acheson Colloids Company of Port Huron, Mich. under the trade designations PD034 or PD004A polymer thick high conductive film. The resistivity of the ink and consequently that of conductive coating 40 may be adjusted for better calibration of the tester. This can be done by mixing into the silver ink a polymer based conductive graphite ink having a higher resistivity than the silver ink. A preferred polymer based conductive graphite ink is available under the trade designation PD003 graphite ink from Acheson Colloids Company. Suitable conductive coating 40 compositions may contain between 75 and 100 wt % silver ink and between 0 and 25 wt % polymer based conductive graphite ink. The sheet resistivity of the conductive layer 94 can also be controlled by adjusting its thickness.

The electrically conductive layer 94 is formed by applying the silver ink in varying geometrical patterns, for example, in a pattern which gradually narrows with length. Such patterns for the conductive coating are disclosed, for example, in U.S. Pat. No. 5,188,231, herein incorporated by reference. The silver ink may be applied by conventional printing methods after which it is dried and heat cured. The total resistance of conductive coating 40 may be between about 0.5 and 2 ohms.

The conductive layer 94 can be applied to form a taper as is conventional in calibrated battery testers or other geometric forms or patterns that provide adequate heat to the thermochromic layer 90 while preferably minimizing the amount of conductive material necessary as it is often expensive.

The dielectric layer 98 preferably has a thickness between about 0.2 and 0.5 mil (0.005 and 0.012 mm). A preferred dielectric layer 98 is a U.V. (ultra violet light) curable polymer coating containing acrylate functional oligomers such as that available under the trade designation PD011 U.V. Dielectric Blue from Acheson Colloids Company.

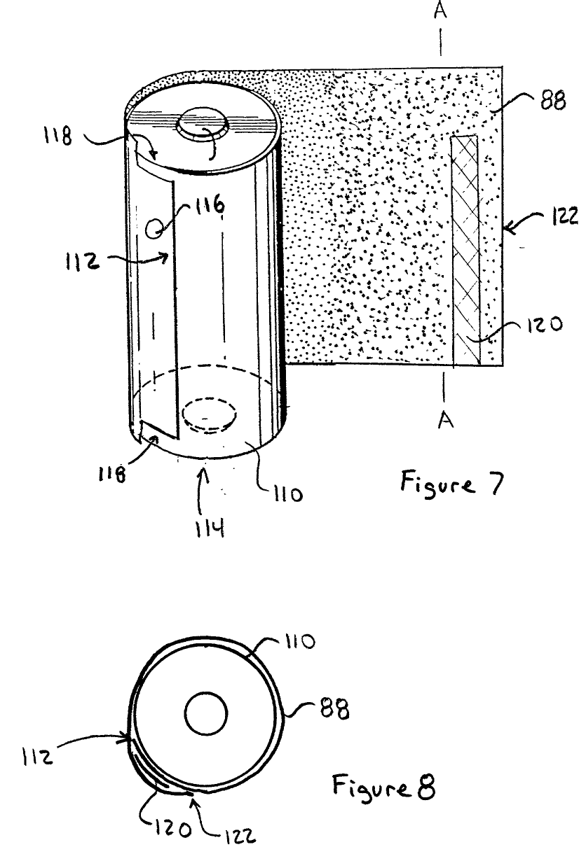

As shown in FIGS. 7 and 8, the label 88 is generally rectangular like the label 60, but is sized to overlap itself sufficiently that the battery tester components, and specifically the conductive layer 94 and thermochromic layer 96, are separated from the battery case 110 by the initial wrapping of the leading label end 112 around the battery 114 when the label is wrapped completely around the battery. (The amount of overlap is generally designated in FIG. 7 as the area to the right of the phantom line A-A.) The label 88 includes an opening 116 near the leading label end 112 to permit one terminal end of the conductive layer 94 to contact the conductive cylindrical can of the battery, which is connected to the positive battery terminal. A pair of notches 118 in the label 88, also near the leading label end 112, and approximately equal in length to the label overlap, allows the other terminal end of the conductive layer 94 to contact the negative terminal of the battery. The notches 118 also reduce the thickness of the label that is heat shrunk around the ends of the battery. The battery tester layers 90, 92, 94, 96, 98 and 100 (herein collectively referred to as the battery tester 120) are offset on the label 88 near the trailing label end 122 so that when the label is wrapped around the battery case 112, the battery tester 120 is separated from the battery case by the leading end 112 of the label and positioned above the opening 116 and one of the notches 118.

The overwrap of the label 88, which effectively separates the battery tester 120 from the battery can by the leading label end 112, acts to thermally insulate the battery tester from the battery can. In this way, the air gap or paper insulator typically in many thermochromic battery tester designs can be eliminated or reduced, thereby reducing the thickness of the tester label as well as the cost and complexity of the manufacturing process.

The dual simplex label construction described herein can also be used with thermochromic battery testers without the specific overwrapping configuration shown in FIGS. 7 and 8. Moreover, the dual simplex label construction could also be employed with other types of battery testers, such as electrochromic battery testers and the like.

Although the invention has been shown and described with respect to certain preferred embodiments, it is obvious that equivalent alterations and modifications will occur to others skilled in the art upon the reading and understanding of this specification. The present invention includes all such equivalent alterations and modifications and is limited only by the scope of the following claims.

What is claimed is:

1. A multilayer label for a battery, comprising:
a transparent, shrinkable outer film forming the outermost layer of the label;
a transparent, shrinkable carrier film having a first transparent adhesive layer on one side confronting the outer layer and bonding the carrier layer to the outer layer and an outwardly visible indicia layer on other side; and
a second transparent adhesive layer adjacent the indicia layer for bonding the label to the battery.

2. The label of claim 1, wherein at least one of the outer film and the carrier film are made of polyvinyl chloride.

3. The label of claim 1, wherein at least one of the outer film and the carrier film are made of polypropylene.

4. The label of claim 1, wherein at least one of the outer film and the carrier film are made of polyester.

5. The label of claim 1, wherein the outer film has balanced oriented shrinkage properties.

6. The label of claim 1, wherein the carrier film has mono-axially oriented shrinkage properties.

7. The label of claim 1, wherein the outer film has balanced oriented shrinkage properties and the carrier film has mono-axially oriented shrinkage properties.

8. The label of claim 1, wherein the indicia layer includes a non-metallic pigment that produces the effect of a metallized label.

9. The label of claim 1, wherein the outer film and the carrier film include a coextruded film composite comprising two distinct film layers.

10. The label of claim 1, including a layer of thermochromic material.

11. The label of claim 10, including a conductive layer in thermal contact with the thermochromic layer.

12. The label of claim 10, wherein the length dimension of at least one of the outer film and the carrier film exceeds the circumference of the battery by an amount at least equal to the width of the conductive layer.

13. The label of claim 10, wherein the conductive layer, when the label is wrapped around a battery, is confronted on both sides by at least one of the outer film and the carrier film.

14. The label of claim 1, wherein the outer film has a thickness in the range of about 10 to 25 microns.

15. The label of claim 1, wherein the carrier film has a thickness in the range of about 25 to 50 microns.

16. The label of claim 1, further including a release liner confronting the second adhesive layer.

17. A battery power indicator label for a dry-cell battery, comprising:
at least one transparent, shrinkable base film having a printed indicia layer, a layer of thermochromic material, a layer of electrically conductive material and a pressure sensitive adhesive on one side, with the layer of thermochromic material and the layer of conductive material forming a battery power indicator;
wherein the length of the film exceeds the circumference of the battery by at least the width of the battery power indicator so that when the label is wrapped around the battery, the battery power indicator is situated between two portions of the film.

18. The label of claim 17, wherein the base film is made of polyvinyl chloride.

19. The label of claim 17, wherein the base film is made of polypropylene.

20. The label of claim 17, wherein the base film is made of polyester.

21. The label of claim 17, wherein the indicia layer includes a non-metallic pigment that produces the effect of a metallized label.

22. The label of claim 17, including an outer film bonded to the outer surface of the base film opposite the indicia layer.

23. The label of claim 17 wherein the film includes an opening allowing a portion of the conductive material to contact a terminal of the battery when the label is wrapped around the battery.

24. A multilayer battery power indicator label for a battery, comprising:
a transparent, shrinkable outer film forming the outermost layer of the label;
a transparent, shrinkable carrier film having a first transparent adhesive layer on one side confronting the outer layer and bonding the carrier layer to the outer layer and an outwardly visible indicia layer, a layer of thermochromic material, a layer of electrically conductive material and a second adhesive layer on the other side;
with the layer of thermochromic material and the layer of conductive material cooperatively acting as a battery power indicator; and
a release liner confronting the second adhesive layer.

25. The label of claim 24, wherein the layer of thermochromic material and the layer of conductive material are on opposites sides of the second adhesive layer.

26. The label of claim 24, wherein the lengths of the outer and carrier films exceeds the circumference of the battery by at least the width of the battery power indicator so that when the label is wrapped around the battery, the battery power indicator is situated between two portions of the films.

27. The label of claim 24, wherein the outer film has balanced oriented shrinkage properties.

28. The label of claim 24, wherein the carrier film has mono-axially oriented shrinkage properties.
